(19) United States
(12) Patent Application Publication
(10) Pub. No.: US 2025/0008247 A1
(43) Pub. Date: Jan. 2, 2025

(54) BRANCHING APPARATUS, METHOD FOR CONTROLLING BRANCHING APPARATUS, AND NON-TRANSITORY COMPUTER READABLE MEDIUM

(71) Applicant: NEC Corporation, Tokyo (JP)

(72) Inventor: Andre ARASHIRO, Tokyo (JP)

(73) Assignee: NEC Corporation, Tokyo (JP)

(21) Appl. No.: 18/752,864

(22) Filed: Jun. 25, 2024

(30) Foreign Application Priority Data
Jun. 30, 2023 (JP) 2023-108340

(51) Int. Cl. H04Q 11/00

(52) U.S. Cl. CPC H04Q 11/0005

(57) ABSTRACT

In a branching apparatus according to the present disclosure, a first input port of the first optical switch connects to a first transmission line A1 connected to a first terminal station A. A second input port connects to a first transmission line C1 connected to a third terminal station C. A first output port connects to a first input port of the second optical switch. A second output port connects to a first transmission line B1 connected to a second terminal station B. A second input port of the second optical switch connects to a second transmission line B2 connected to the second terminal station B. The first output port connects to a second transmission line A2 connected to the first terminal station A. The second output port connects to a second transmission line C2 connected to the third terminal station C.

### INCORPORATION BY REFERENCE

This application is based upon and claims the benefit of priority from Japanese patent application No. 2023-108340, filed on Jun. 30, 2023, the disclosure of which is incorporated herein in its entirety by reference.

### TECHNICAL FIELD

The present disclosure relates to a branching apparatus, a method for controlling a branching apparatus, and a non-transitory computer readable medium.

### BACKGROUND ART

In a submarine optical cable system, optical transmission apparatuses provided at terminal stations on land transmit a wavelength-multiplexed optical signal to each other via a submarine optical cable. Further, a branching apparatus is installed in the middle of a submarine optical cable connecting a first terminal station and a second terminal station, and further connects to a third terminal station via the submarine optical cable. The branching apparatus is configured to branch an optical signal transmitted between the first terminal station and the second terminal station to the third terminal station, and thereby enable the first terminal station or the second terminal station to perform optical communication with the third terminal station.

International Patent Publication No. WO2020/194842 discloses a branching apparatus including a circuit in which a 1×2 optical switch and a 2×2 optical switch are connected in multiple stages, for establishing a path branching an optical signal transmitted between a first terminal station and a second terminal station to a third terminal station.

### SUMMARY

An object of the branching apparatus according to International Patent Publication No. WO2020/194842 is to reduce the number of optical switches being used for establishing an optical communication path between terminal stations. For example, in the branching apparatus according to International Patent Publication No. WO2020/194842, the number of fiber pairs to be connected to a terminal station is limited by an upper limit of the number of optical switches to be mounted in a housing of the branching apparatus. Further, in the branching apparatus according to International Patent Publication No. WO2020/194842, there is a possibility that another information processing equipment is to be accommodated in the housing of the branching apparatus, and therefore, it is necessary to secure a space in the housing.

In view of such problems, an example object of the present disclosure is to provide a branching apparatus, a method for controlling a branching apparatus, and a non-transitory computer readable medium that enable reduction in the number of optical switches being used for establishing an optical communication path between terminal stations.

A branching apparatus according to the present disclosure includes an optical switch drive circuit, wherein
the optical switch drive circuit is configured to include first and second optical switches having first and second input ports to which an optical signal is input and first and second output ports which output an optical signal, the first and second optical switches being capable of switching an optical signal transmission path between the input port and the output port,
a first input port of the first optical switch connects to a first transmission line connected to a first terminal station, a second input port of the first optical switch connects to a first transmission line connected to a third terminal station, a first output port of the first optical switch connects to a transmission line connected to a first input port of the second optical switch, and a second output port of the first optical switch connects to a first transmission line connected to a second terminal station, and
a first input port of the second optical switch connects to a transmission line connected to a first output port of the first optical switch, a second input port of the second optical switch connects to a second transmission line connected to the second terminal station, a first output port of the second optical switch connects to a second transmission line connected to the first terminal station, and a second output port of the second optical switch connects to a second transmission line connected to the third terminal station.

A method for controlling a branching apparatus according to the present disclosure includes controlling switching of a transmission path in first and second optical switches, wherein
the branching apparatus is configured to include an optical switch drive circuit which includes the first and second optical switches having first and second input ports to which an optical signal is input and first and second output ports which output an optical signal, the first and second optical switches being capable of switching the optical signal transmission path between the input port and the output port,
a first input port of the first optical switch connects to a first transmission line connected to a first terminal station, a second input port of the first optical switch connects to a first transmission line connected to a third terminal station, a first output port of the first optical switch connects to a transmission line connected to a first input port of the second optical switch, and a second output port of the first optical switch connects to a first transmission line connected to a second terminal station, and
a first input port of the second optical switch connects to a transmission line connected to a first output port of the first optical switch, a second input port of the second optical switch connects to a second transmission line connected to the second terminal station, a first output port of the second optical switch connects to a second transmission line connected to the first terminal station, and a second output port of the second optical switch connects to a second transmission line connected to the third terminal station.

A non-transitory computer readable medium storing a program causing a computer to execute processing of controlling switching of a transmission path in first and second optical switches, wherein
the branching apparatus is configured to include an optical switch drive circuit which includes the first and second optical switches having first and second input ports to which an optical signal is input and first and second output ports which output an optical signal, the first and second optical switches being capable of switching the optical signal transmission path between the input port and the output port,
a first input port of the first optical switch connects to a first transmission line connected to a first terminal station, a second input port of the first optical switch connects to a first transmission line connected to a third terminal station, a first input port of the first optical switch is connected to a transmission line connected to a first input port of the second optical switch, and a second output port of the first optical switch connects to a first transmission line connected to a second terminal station, and
a first input port of the second optical switch connects to a transmission line connected to a first output port of the first optical switch, a second input port of the second optical switch connects to a second transmission line connected to the second terminal station, a first output port of the second optical switch connects to a second transmission line connected to the first terminal station, and a second output port of the second optical switch connects to a second transmission line connected to the third terminal station.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram illustrating one example of a configuration of an optical switch drive circuit 20 of a branching apparatus 100 according to the present disclosure;

FIG. 2 is a block diagram illustrating one example of a configuration of a branching apparatus 200 according to the present disclosure;

FIG. 3 is a diagram illustrating an outline of a path configuration established in an optical switch drive circuit 20 of the branching apparatus 200 according to the present disclosure;

FIG. 4 is a diagram illustrating one example of a path configuration state established in the optical switch drive circuit 20 of the branching apparatus 200 according to the present disclosure;

FIG. 5 is a diagram illustrating one example of a configuration in State 2 of the optical switch drive circuit 20 of the branching apparatus 200 according to the present disclosure;

FIG. 6 is a diagram illustrating one example of a configuration in State 3 of the optical switch drive circuit 20 of the branching apparatus 200 according to the present disclosure;

FIG. 7 is a diagram illustrating one example of a configuration in State 5 of the optical switch drive circuit 20 of the branching apparatus 200 according to the present disclosure;

FIG. 8 is a diagram illustrating one example of a configuration in State 2 of an optical switch drive circuit 20R of a branching apparatus 200R according to a first comparative example;

FIG. 9 is a diagram illustrating one example of a configuration in State 3 of the optical switch drive circuit 20R of the branching apparatus 200R according to the first comparative example;

FIG. 10 is a diagram illustrating one example of a configuration in State 5 of the optical switch drive circuit 20R of the branching apparatus 200R according to the first comparative example; and

FIG. 11 is a block diagram illustrating one example of a configuration of a computer 1000 according to the present disclosure.

### EXAMPLE EMBODIMENT

Hereinafter, specific example embodiments to which the present invention is applied is described in detail with reference to the drawings. In the drawings, the same element is denoted by the same reference sign, and redundant descriptions are omitted as necessary for clarity of description.

### (First Example Embodiment)

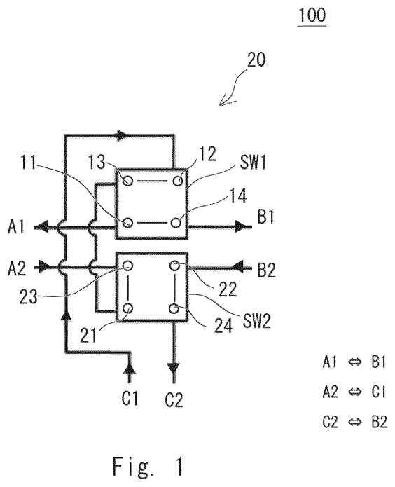

First, the configuration of a branching apparatus 100 according to a first example embodiment is described with reference to FIG. 1. FIG. 1 is a diagram illustrating one example of a configuration of an optical switch drive circuit 20 of the branching apparatus 100 according to the first example embodiment.

The branching apparatus 100 according to the present disclosure includes the optical switch drive circuit 20. The optical switch drive circuit 20 includes a first optical switch SW1 and a second optical switch SW2 that have first and second input ports to which an optical signal is input and first and second output ports which output an optical signal, and that are capable of switching an optical signal transmission path between the input port and the output port.

The first optical switch SW1 has a first input port 11, a second input port 12, a first output port 13, and a second output port 14. The first input port 11 of the first optical switch SW1 connects to a first transmission line A1 connected to a first terminal station A. The second input port 12 connects to a first transmission line C1 connected to a third terminal station C. The first output port 13 connects to a transmission line connected to the first input port 21 of the second optical switch SW2. The second output port 14 connects to a first transmission line B1 connected to a second terminal station B.

The second optical switch SW2 has a first input port 21, a second input port 22, a first output port 23, and a second output port 24. The first input port 21 of the second optical switch SW2 connects to the transmission line connected to the first output port 13 of the first optical switch SW1. The second input port 22 connects to a second transmission line B2 connected to the second terminal station B. The first output port 23 connects to a second transmission line A2 connected to the first terminal station A. The second output port 24 connects to a second transmission line C2 connected to the third terminal station C.

In the branching apparatus 100 according to the first example embodiment, the optical switch drive circuit 20 is configured by using an optical switch SW being a 2×2 optical switch, without using a 1×2 optical switch. Thereby, the branching apparatus 100 is able to reduce the number of optical switches SW necessary for establishing the optical communication path between the terminal stations.

### (Second Example Embodiment)

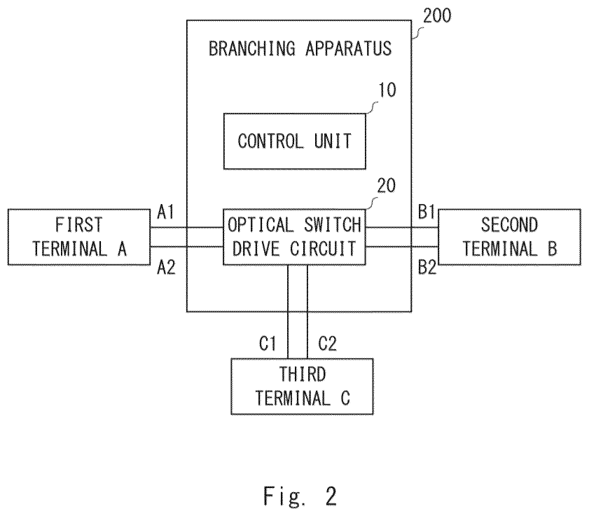

Next, a configuration of a branching apparatus 200 according to the second example embodiment is described with reference to FIGS. 2 to 7.

FIG. 2 is a block diagram illustrating one example of a configuration of the branching apparatus 200 according to the present disclosure. As illustrated in FIG. 2, the branching apparatus 200 is a branching apparatus installed on the seabed in a submarine optical cable system. The branching apparatus 200 includes an optical switch drive circuit 20 and a control unit 10.

The control unit 10 controls the optical switch drive circuit 20. For example, the control unit 10 controls the optical switch drive circuit 20, based on a control signal from an external device remote from the branching apparatus 200.

The optical switch drive circuit 20 connects to a transmission line (optical submarine cable) connected to each of a first terminal station A, a second terminal station B, and a third terminal station C. The first terminal station A, the second terminal station B, and the third terminal station C are terminal stations installed on land and terminating the transmission line. The first terminal station A and the second terminal station B are trunk stations. The third terminal station C is a branch station. Specifically, the optical switch drive circuit 20 connects to a first transmission line A1 and a second transmission line A2 connected to the first terminal station A. The branching apparatus 200 connects to a first transmission line B1 and a second transmission line B2 connected to the second terminal station B. Further, the branching apparatus 200 connects to a first transmission line C1 and a second transmission line C2 connected to the third terminal station C. Herein, each transmission line is constituted by an input/output fiber pair.

Then, the optical switch drive circuit 20 branches a wavelength-multiplexed optical signal (hereinafter, an optical signal) transmitted and received between the first terminal station A and the second terminal station B, which are trunk stations, to the third terminal station C, which is a branch station, in such a way that the first terminal station A or the second terminal station B is able to perform optical communication with the third terminal station C. Specifically, as described below, the optical switch drive circuit 20 establishes a path between all possible combinations of two branches among the three branches of the first terminal station A, the second terminal station B, and the third terminal station C.

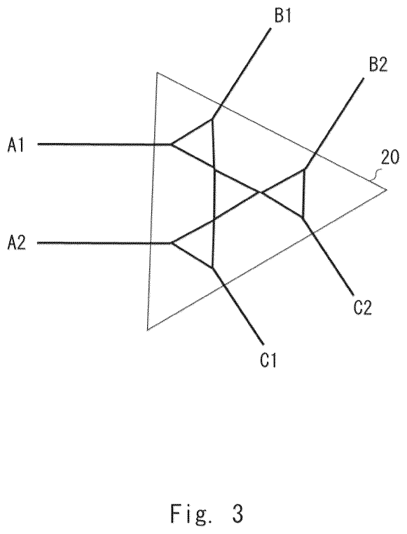

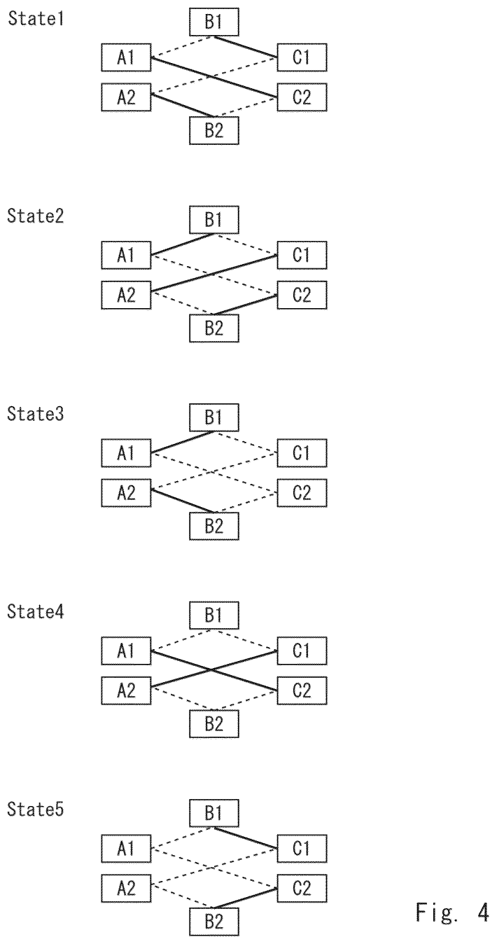

FIG. 3 is a diagram illustrating an outline of a path configuration established in the optical switch drive circuit 20 of the branching apparatus 200 according to the present disclosure. FIG. 4 is a diagram illustrating one example of a path configuration state established in the optical switch drive circuit 20 of the branching apparatus 200 according to the present disclosure. As illustrated in FIGS. 3 and 4, the optical switch drive circuit 20 establishes optical paths of States 2, 3 and 5 among the path configuration states of States 1 to 5. In State 2, the optical switch drive circuit 20 establishes an optical path between the first transmission line A1 and the first transmission line B1, between the second transmission line A2 and the first transmission line C1, and between the second transmission line B2 and the second transmission line C2. In State 3, the optical switch drive circuit 20 establishes an optical path between the first transmission line A1 and the first transmission line B1 and between the second transmission line A2 and the second transmission line B2. In State 5, the optical switch drive circuit 20 establishes an optical path between the first transmission line B1 and the first transmission line C1 and between the second transmission line B2 and the second transmission line C2.

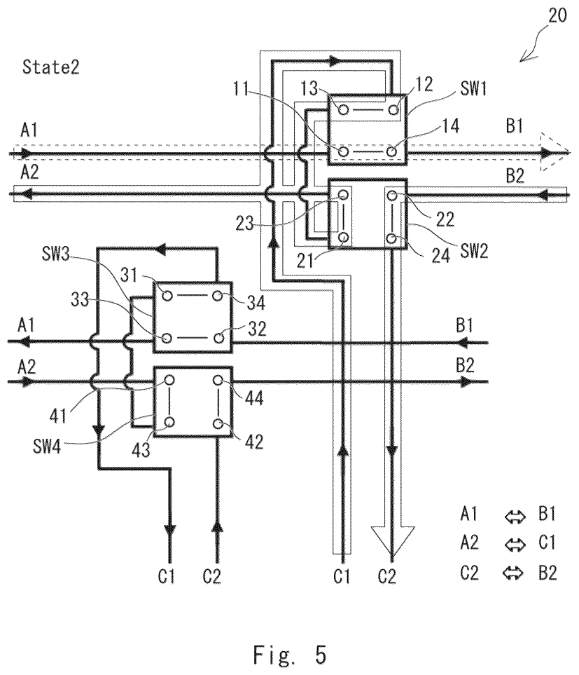

Next, a specific configuration of the optical switch drive circuit 20 of the branching apparatus 200 according to the present disclosure is described with reference to FIGS. 5 to 7.

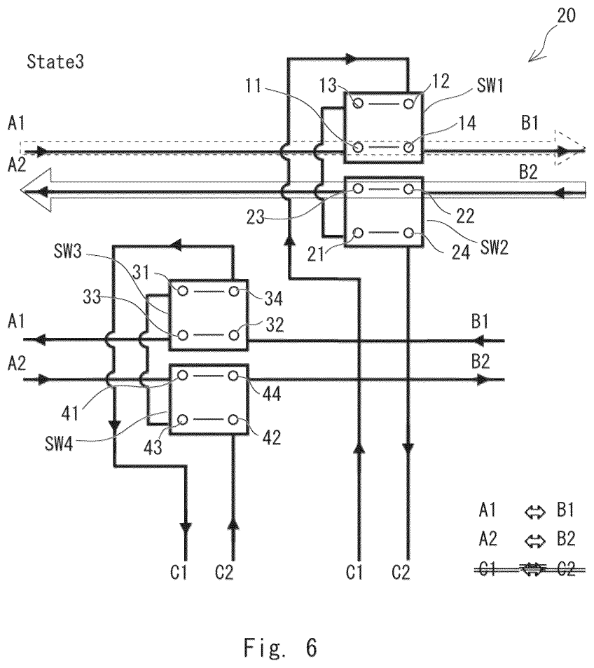

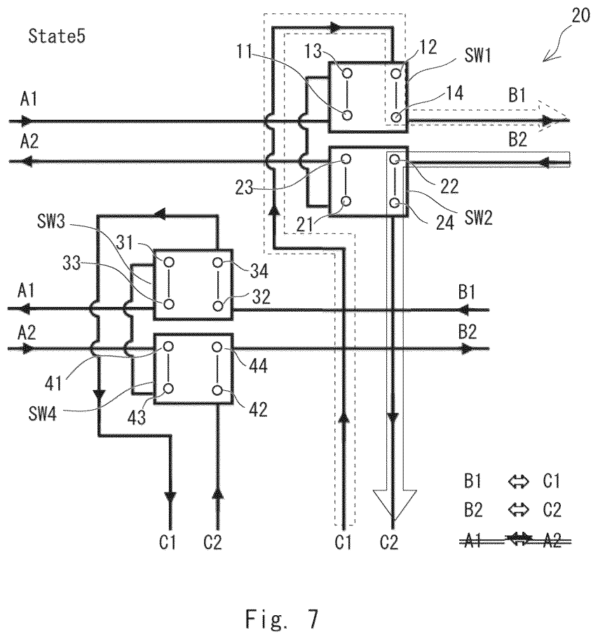

FIG. 5 is a diagram illustrating one example of a configuration in State 2 of the optical switch drive circuit 20 of the branching apparatus 200 according to the present disclosure. FIG. 6 is a diagram illustrating one example of a configuration in State 3 of the optical switch drive circuit 20 of the branching apparatus 200 according to the present disclosure. FIG. 7 is a diagram illustrating one example of a configuration in State 5 of the optical switch drive circuit 20 of the branching apparatus 200 according to the present disclosure.

### <Common Configuration of Optical Switch Drive Circuit 20 in States 2, 3, and 5>

As illustrated in FIGS. 5 to 7, the optical switch drive circuit 20 of the branching apparatus 200 includes a first optical switch SW1, a second optical switch SW2, a third optical switch SW3, and a fourth optical switch SW4 (collectively referred to as an optical switch SW). Each optical switch SW is a 2×2 optical switch. The optical switch SW is, for example, an optical waveguide switch, a mechanical switch, or a micro electro mechanical systems (MEMS) switch. Each optical switch SW includes two optical signal input ports and two optical signal output ports, and switches a connection between a predetermined input port and output port to a connection between another input port and output port.

The first optical switch SW1 has a first input port 11, a second input port 12, a first output port 13, and a second output port 14. The first input port 11 of the first optical switch SWI connects to the first transmission line A1. The second input port 12 of the first optical switch SW1 connects to the first transmission line C1. The first output port 13 of the first optical switch SW1 connects to a transmission line connected to a first input port 21 of the second optical switch SW2. The second output port 14 of the first optical switch SW1 connects to the first transmission line B1.

The second optical switch SW2 has the first input port 21, a second input port 22, a first output port 23, and a second output port 24. The first input port 21 of the second optical switch SW2 connects to the first output port 13 of the first optical switch SW1. The second input port 22 of the second optical switch SW2 connects to the second transmission line B2. The first output port 23 of the second optical switch SW2 connects to the second transmission line A2. The second output port 24 of the second optical switch SW2 connects to the second transmission line C2.

The third optical switch SW3 has a first input port 31, a second input port 32, a first output port 33, and a second output port 34. The first input port 31 of the third optical switch SW3 connects to a first output port 43 of the fourth optical switch SW4. The second input port 32 of the third optical switch SW3 connects to the first transmission line B1. The first output port 33 of the third optical switch SW3 connects to the first transmission line A1. The second output port 34 of the third optical switch SW3 connects to the first transmission line C1.

The fourth optical switch SW4 has a first input port 41, a second input port 42, the first output port 43, and a second output port 44. The first input port 41 of the fourth optical switch SW4 connects to the second transmission line A2. The second input port 42 of the fourth optical switch SW4 connects to the second transmission line C2. The first output port 43 of the fourth optical switch SW4 connects to the first input port 31 of the third optical switch SW3. The second output port 44 of the fourth optical switch SW4 connects to the second transmission line B2.

### <Configuration of Optical Switch Drive Circuit 20 in Each of States 2, 3, and 5>

In State 2, as illustrated in FIG. 5, the first optical switch SW1 and the third optical switch SW3 of the optical switch drive circuit 20 are each connected to a horizontal path. The second optical switch SW2 and the fourth optical switch SW4 are each connected to a vertical path. Specifically, the first optical switch SW1 connects the first input port 11 and the second output port 14, and connects the second input port 12 and the first output port 13. The second optical switch SW2 connects the first input port 21 and the first output port 23, and connects the second input port 22 and the second output port 24. The third optical switch SW3 connects the second input port 32 and the first output port 33, and connects the first input port 31 and the second output port 34. The fourth optical switch SW4 connects the first input port 41 and the first output port 43, and connects the second input port 42 and the second output port 44. Thereby, the optical switch drive circuit 20 achieves bidirectional optical communication between the first transmission line A1 and the first transmission line B1, between the second transmission line A2 and the first transmission line C1, and between the second transmission line C2 and the second transmission line B2. Further, in a case where the optical communication path is established between the first transmission line C1 and the second transmission line C2 in the third terminal station C, the optical switch drive circuit 20 achieves bidirectional optical communication between the second transmission line A2 and the second transmission line B2.

In State 3, as illustrated in FIG. 6, the first optical switch SW1, the second optical switch SW2, the third optical switch SW3, and the fourth optical switch SW4 of the optical switch drive circuit 20 are each connected to a horizontal path. Specifically, the first optical switch SW1 connects the first input port 11 and the second output port 14, and connects the second input port 12 and the first output port 13. The second optical switch SW2 connects the first input port 21 and the second output port 24, and connects the second input port 22 and the first output port 23. The third optical switch SW3 connects the first input port 31 and the second output port 34, and connects the second input port 32 and the first output port 33. The fourth optical switch SW4 connects the first input port 41 and the second output port 44, and connects the second input port 42 and the first output port 43. Thereby, the optical switch drive circuit 20 achieves bidirectional optical communication between the first transmission line A1 and the first transmission line B1 and between the second transmission line A2 and the second transmission line B2.

In State 5, as illustrated in FIG. 7, the first optical switch SW1, the second optical switch SW2, the third optical switch SW3, and the fourth optical switch SW4 of the optical switch drive circuit 20 are each connected to a vertical path. Specifically, the first optical switch SW1 connects the first input port 11 and the first output port 13, and connects the second input port 12 and the second output port 14. The second optical switch SW2 connects the first input port 21 and the first output port 23, and connects the second input port 22 and the second output port 24. The third optical switch SW3 connects the first input port 31 and the first output port 33, and connects the second input port 32 and the second output port 34. The fourth optical switch SW4 connects the first input port 41 and the first output port 43, and connects the second input port 42 and the second output port 44. Thereby, the optical switch drive circuit 20 achieves bidirectional optical communication between the first transmission line B1 and the first transmission line C1 and between the second transmission line B2 and the second transmission line C2.

In States 2, 3, and 5, the control unit 10 controls the switching between the connection of the horizontal path and the connection of the vertical path in the first optical switch SW1 to the fourth optical switch SW4 of the optical switch drive circuit 20.

As described above, in the branching apparatus 200 according to the second example embodiment, the optical switch drive circuit 20 is configured by using the optical switch SW being a 2×2 optical switch, without using a 1×2 optical switch. Thereby, the branching apparatus 200 is able to reduce the number of optical switches SW required to establish the optical communication path among the first terminal station A, the second terminal station B, and the third terminal station C.

For example, the branching apparatus 200 is able to reduce the number of optical switches SW required for establishing an optical communication path among the first terminal station A to the third terminal station C to ½ as compared with a branching apparatus according to International Patent Publication No. WO2020/194842. The branching apparatus according to International Patent Publication No. WO2020/194842 requires eight 1×2 optical switches for two transmission lines connected from each of the first terminal station A, the second terminal station B, and the third terminal station C. Meanwhile, the branching apparatus 200 according to the present example embodiment requires four 2×2 optical switches for two transmission lines connected from each of the first terminal station A, the second terminal station B, and the third terminal station C. Therefore, the branching apparatus 200 is able to reduce the number of required optical switches SW to ½.

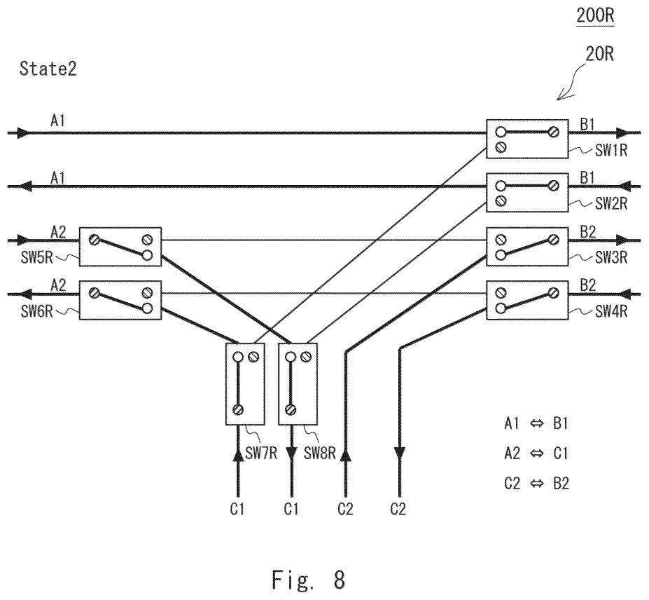

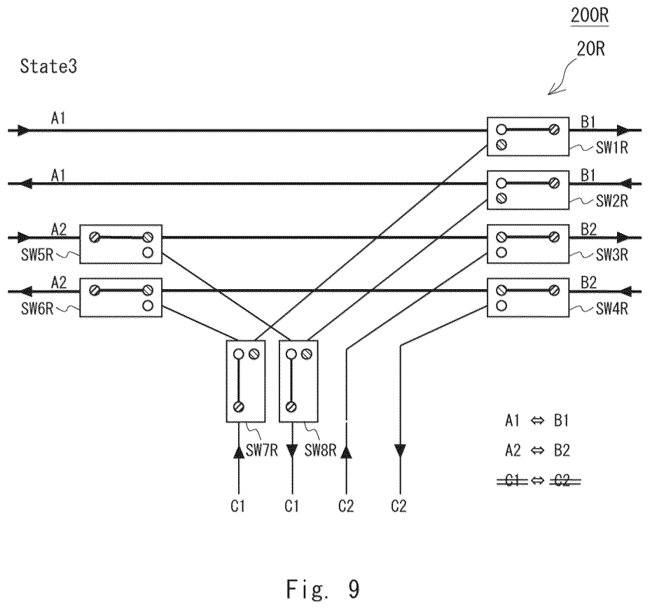

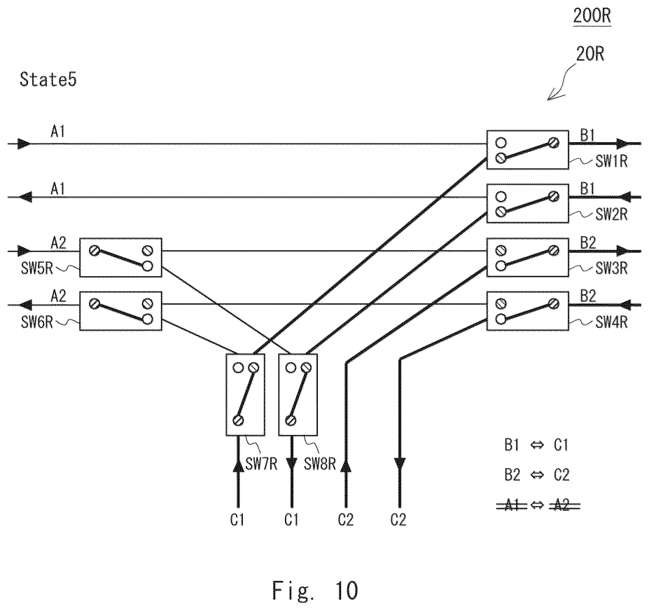

Further, the branching apparatus 200 is able to reduce the number of optical switches SW required for establishing an optical communication path among the first terminal station A to the third terminal station C to ½ as compared with an optical switch drive circuit 20R of a branching apparatus 200R according to a first comparative example illustrated in FIGS. 8 to 10 described below. FIG. 8 illustrates one example of a configuration in State 2 of the optical switch drive circuit 20R of the branching apparatus 200R according to the first comparative example. FIG. 9 illustrates one example of a configuration in State 3 of the optical switch drive circuit 20R of the branching apparatus 200R according to the first comparative example. FIG. 10 illustrates one example of a configuration in State 5 of the optical switch drive circuit 20R of the branching apparatus 200R according to the first comparative example. As illustrated in FIGS. 8 to 10, the branching apparatus 200R of the first comparative example requires eight 1×2 optical switches (optical switches SWIR to SW8R) for two transmission lines connected from each of the first terminal station A, the second terminal station B and the third terminal station C. Meanwhile, the branching apparatus 200 according to the present example embodiment requires four 2×2 optical switches for two transmission lines connected from each of the first terminal station A, the second terminal station B, and the third terminal station C. Therefore, the branching apparatus 200 is able to reduce the number of required optical switches SW to ½.

Accordingly, the branching apparatus 200 is able to reduce the number of optical switches SW when establishing a path. Therefore, the branching apparatus 200 is able to secure a space in the housing of the branching apparatus 200 by the number of the reduced optical switches SW. Therefore, the branching apparatus 200 is able to increase the number of transmission lines connecting to the terminal station and the optical switch SW. Further, the branching apparatus 200 is able to increase the number of optical switches SW that can be mounted in the housing. Further, the branching apparatus 200 is able to increase the number of other information processing devices that may be mounted in the housing. Further, the branching apparatus 200 is able to reduce the required cost by the reduced number of optical switches SW.

### <Hardware Configuration>

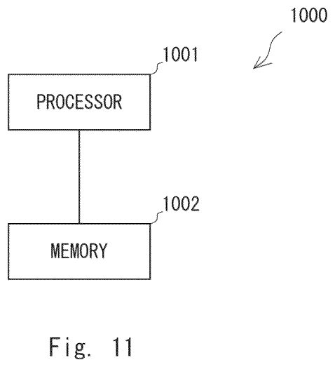

Next, a hardware configuration example of a computer 1000 is described with reference to FIG. 11. In FIG. 11, the computer 1000 includes a processor 1001 and a memory 1002. The processor 1001 may be, for example, a microprocessor, a micro processing unit (MPU), or a central processing unit (CPU). The processor 1001 may include a plurality of processors. The memory 1002 is configured of a combination of a volatile memory and a non-volatile memory. The memory 1002 may include a storage located away from the processor 1001. In such a case, the processor 1001 may access the memory 1002 via an I/O interface (not illustrated).

The function (processing) of each components (for example, the control unit 10) of the branching apparatus 100 and the branching apparatus 200 in the above-described example embodiments may be implemented by the computer 1000. For example, a program for performing the method according to the example embodiments may be stored in the memory 1002, and each function may be implemented by executing the program stored in the memory 1002 by the processor 1001. Further, each component according to the above-described example embodiments is configured by hardware, software, or both, and may be configured by one piece of hardware or software, or may be configured by a plurality of pieces of hardware or software.

These programs include instructions (or software code) that, when loaded into a computer, cause the computer to perform one or more of the functions described in the example embodiments. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that, the present invention is not limited to the above-described example embodiments, and may be appropriately modified without departing from the spirit.

In the above-described example embodiments, the optical switch drive circuit 20 of the branching apparatus 200 establishes an optical path of States 2, 3 and 5 among the path configuration states of States 1 to 5 in order to establish an optical communication path centered on the second terminal station B, which is a trunk station. In the case of establishing an optical communication path centered on the first terminal station A, which is the other trunk station, the branching apparatus 200 includes the optical switch drive circuit 20 having the first terminal station A as the second terminal station B and the second terminal station B as the first terminal station A.

The first and second example embodiments may be combined as desirable by one of ordinary skill in the art.

According to the present disclosure, it is possible to provide a branching apparatus and a method for controlling a branching apparatus that enable reduction in the number of optical switches to be used for establishing an optical communication path between terminal stations.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

Some or all of the above-described embodiments may be described as the following supplementary notes, but are not limited thereto.

### (Supplementary Note 1)

A branching apparatus including an optical switch drive circuit, wherein the optical switch drive circuit is configured to include first and second optical switches having first and second input ports to which an optical signal is input and first and second output ports which output an optical signal, the first and second optical switches being capable of switching an optical signal transmission path between the input port and the output port,
a first input port of the first optical switch connects to a first transmission line connected to a first terminal station, a second input port of the first optical switch connects to a first transmission line connected to a third terminal station, a first output port of the first optical switch connects to a transmission line connected to a first input port of the second optical switch, and a second output port of the first optical switch connects to a first transmission line connected to a second terminal station, and
a first input port of the second optical switch connects to a transmission line connected to a first output port of the first optical switch, a second input port of the second optical switch connects to a second transmission line connected to the second terminal station, a first output port of the second optical switch connects to a second transmission line connected to the first terminal station, and a second output port of the second optical switch connects to a second transmission line connected to the third terminal station.

### (Supplementary Note 2)

The branching apparatus according to supplementary note 1, wherein, in a case where an optical signal transmission path is being established between a first transmission line connected to the first terminal station and a first transmission line connected to the second terminal station, between a second transmission line connected to the first terminal station and a first transmission line connected to the third terminal station, and between a second transmission line connected to the third terminal station and a second transmission line connected to the second terminal station,
the first optical switch connects the first input port and the second output port to each other, and connects the second input port and the first output port to each other, and
the second optical switch connects the first input port and the first output port to each other, and connects the second input port and the second output port to each other.

### (Supplementary Note 3)

The branching apparatus according to supplementary note 1, wherein, in a case where an optical signal transmission path is being established between a first transmission line connected to the first terminal station and a first transmission line connected to the second terminal station, and between a second transmission line connected to the first terminal station and a second transmission line connected to the second terminal station,
the first optical switch connects the first input port and the second output port to each other, and connects the second input port and the first output port to each other, and
the second optical switch connects the first input port and the second output port to each other, and connects the second input port and the first output port to each other.

### (Supplementary Note 4)

The branching apparatus according to supplementary note 1, wherein, in a case where an optical signal transmission path is being established between a first transmission line connected to the second terminal station and a first transmission line connected to the third terminal station, and between a second transmission line connected to the second terminal station and a second transmission line connected to the third terminal station,
the first optical switch connects the first input port and the first output port to each other, and connects the second input port and the second output port to each other, and
the second optical switch connects the first input port and the first output port to each other, and connects the second input port and the second output port to each other.

### (Supplementary Note 5)

The branching apparatus according to supplementary note 1, wherein the optical switch drive circuit further includes third and fourth optical switches having first and second input ports to which an optical signal is input and first and second output ports which output an optical signal, the third and fourth optical switches being capable of switching an optical signal transmission path between the input port and the output port,
a first input port of a third optical switch connects to a first output port of a fourth optical switch, a second input port of the third optical switch connects to a first transmission line connected to the second terminal station, a first output port of the third optical switch connects to a first transmission line connected to the first terminal station, and a second output port of the third optical switch connects to a first transmission line connected to the third terminal station, and
a first input port of the fourth optical switch connects to a second transmission line connected to the first terminal station, a second input port of the fourth optical switch connects to a second transmission line connected to the third terminal station, a first output port of the fourth optical switch is connected to a transmission line connected to a first input port of the third optical switch, and a second output port of the fourth optical switch is connected to a second transmission line connected to the second terminal station.

### (Supplementary Note 6)

The branching apparatus according to supplementary note 5, wherein, in a case where an optical signal transmission path is being established between a first transmission line connected to the first terminal station and a first transmission line connected to the second terminal station, between a second transmission line connected to the first terminal station and a first transmission line connected to the third terminal station, and between a second transmission line connected to the third terminal station and a second transmission line connected to the second terminal station,
the third optical switch connects the first input port and the second output port to each other, and connects the second input port and the first output port to each other, and
the fourth optical switch connects the first input port and the first output port to each other, and connects the second input port and the second output port to each other.

### (Supplementary Note 7)

The branching apparatus according to supplementary note 5, wherein, in a case where an optical signal transmission path is being established between a first transmission line connected to the first terminal station and a first transmission line connected to the second terminal station, and between a second transmission line connected to the first terminal station and a second transmission line connected to the second terminal station,
the third optical switch connects the first input port and the second output port to each other, and connects the second input port and the first output port to each other, and
the fourth optical switch connects the first input port and the second output port to each other, and connects the second input port and the first output port to each other.

### (Supplementary Note 8)

The branching apparatus according to supplementary note 5, wherein, in a case where an optical signal transmission path is being established between a first transmission line connected to the second terminal station and a first transmission line connected to the third terminal station, and between a second transmission line connected to the second terminal station and a second transmission line connected to the third terminal station,
the third optical switch connects the first input port and the first output port to each other, and connects the second input port and the second output port to each other, and
the fourth optical switch connects the first input port and the first output port to each other, and connects the second input port and the second output port to each other.

### (Supplementary Note 9)

A method for controlling a branching apparatus including controlling switching of a transmission path in first and second optical switches, wherein
the branching apparatus is configured to include an optical switch drive circuit which includes the first and second optical switches having first and second input ports to which an optical signal is input and first and second output ports which output an optical signal, the first and second optical switches being capable of switching the optical signal transmission path between the input port and the output port,
a first input port of the first optical switch connects to a first transmission line connected to a first terminal station, a second input port of the first optical switch connects to a first transmission line connected to a third terminal station, a first input port of the first optical switch is connected to a transmission line connected to a first input port of the second optical switch, and a second output port of the first optical switch connects to a first transmission line connected to a second terminal station, and
a first input port of the second optical switch connects to a transmission line connected to a first output port of the first optical switch, a second input port of the second optical switch connects to a second transmission line connected to the second terminal station, a first output port of the second optical switch connects to a second transmission line connected to the first terminal station, and a second output port of the second optical switch connects to a second transmission line connected to the third terminal station.

### (Supplementary Note 10)

The method for controlling the branching apparatus according to supplementary note 9 further including, in a case where an optical signal transmission path is being established between a first transmission line connected to the first terminal station and a first transmission line connected to the second terminal station, between a second transmission line connected to the first terminal station and a first transmission line connected to the third terminal station, and between a second transmission line connected to the third terminal station and a second transmission line connected to the second terminal station:
controlling the first optical switch in such a way that the first optical switch connects the first input port and the second output port to each other, and connects the second input port and the first output port to each other; and
controlling the second optical switch in such a way that the second optical switch connects the first input port and the first output port to each other, and connects the second input port and the second output port to each other.

### (Supplementary Note 11)

The method for controlling the branching apparatus according to supplementary note 9 further including, in a case where an optical signal transmission path is being established between a first transmission line connected to the first terminal station and a first transmission line connected to the second terminal station, and between a second transmission line connected to the first terminal station and a second transmission line connected to the second terminal station:
controlling the first optical switch in such a way that the first optical switch connects the first input port and the second output port to each other, and connects the second input port and the first output port to each other; and
controlling the second optical switch in such a way that the second optical switch connects the first input port and the second output port to each other, and connects the second input port and the first output port to each other.

### (Supplementary Note 12)

The method for controlling the branching apparatus according to supplementary note 9 further including, in a case where an optical signal transmission path is being established between a first transmission line connected to the second terminal station and a first transmission line connected to the third terminal station, and between a second transmission line connected to the second terminal station and a second transmission line connected to the third terminal station:
controlling the first optical switch in such a way that the first optical switch connects the first input port and the first output port to each other, and connects the second input port and the second output port to each other; and
controlling the second optical switch in such a way that the second optical switch connects the first input port and the first output port to each other, and connects the second input port and the second output port to each other.

### (Supplementary Note 13)

The method for controlling the branching apparatus according to supplementary note 9, further including controlling switching of a transmission path in third and fourth optical switches, wherein
the optical switch drive circuit further includes the third and fourth optical switches having first and second input ports to which an optical signal is input and first and second output ports which output an optical signal, the third and fourth optical switches being capable of switching the optical signal transmission path between the input port and the output port,
a first input port of a third optical switch connects to a first output port of a fourth optical switch, a second input port of the third optical switch connects to a first transmission line connected to a second terminal station, a first output port of the third optical switch connects to a first transmission line connected to the first terminal station, and a second output port of the third optical switch connects to a first transmission line connected to the third terminal station, and
a first input port of the fourth optical switch connects to a second transmission line connected to the first terminal station, a second input port of the fourth optical switch connects to a second transmission line connected to the third terminal station, a first output port of the fourth optical switch connects to a transmission line connected to a first input port of the third optical switch, and a second output port of the fourth optical switch connects to a second transmission line connected to the second terminal station.

### (Supplementary Note 14)

The method for controlling the branching apparatus according to supplementary note 13, further including, in a case where an optical signal transmission path is being established between a first transmission line connected to the first terminal station and a first transmission line connected to the second terminal station, between a second transmission line connected to the first terminal station and a first transmission line connected to the third terminal station, and between a second transmission line connected to the third terminal station and a second transmission line connected to the second terminal station:
controlling the third optical switch in such a way that the third optical switch connects the first input port and the second output port to each other, and connects the second input port and the first output port to each other; and
controlling the fourth optical switch in such a way that the fourth optical switch connects the first input port and the first output port to each other, and connects the second input port and the second output port to each other.

### (Supplementary Note 15)

The method for controlling the branching apparatus according to supplementary note 13 further including, in a case where an optical signal transmission path is being established between a first transmission line connected to the first terminal station and a first transmission line connected to the second terminal station, and between a second transmission line connected to the first terminal station and a second transmission line connected to the second terminal station:
controlling the third optical switch in such a way that the third optical switch connects the first input port and the second output port to each other, and connects the second input port and the first output port to each other; and
controlling the fourth optical switch in such a way that the fourth optical switch connects the first input port and the second output port to each other, and connects the second input port and the first output port to each other.

### (Supplementary Note 16)

The method for controlling the branching apparatus according to supplementary note 13 further including, in a case where an optical signal transmission path is being established between a first transmission line connected to the second terminal station and a first transmission line connected to the third terminal station, and between a second transmission line connected to the second terminal station and a second transmission line connected to the third terminal station:
controlling the third optical switch in such a way that the third optical switch connects the first input port and the first output port to each other, and connects the second input port and the second output port to each other; and
controlling the fourth optical switch in such a way that the fourth optical switch connects the first input port and the first output port to each other, and connects the second input port and the second output port to each other.

### (Supplementary Note 17)

A program causing a computer to execute processing of controlling switching of a transmission path in first and second optical switches, wherein
the branching apparatus is configured to include an optical switch drive circuit which includes the first and second optical switches having first and second input ports to which an optical signal is input and first and second output ports which output an optical signal, the first and second optical switches being capable of switching the optical signal transmission path between the input port and the output port,
a first input port of the first optical switch connects to a first transmission line connected to a first terminal station, a second input port of the first optical switch connects to a first transmission line connected to a third terminal station, a first input port of the first optical switch is connected to a transmission line connected to a first input port of the second optical switch, and a second output port of the first optical switch connects to a first transmission line connected to a second terminal station, and
a first input port of the second optical switch connects to a transmission line connected to a first output port of the first optical switch, a second input port of the second optical switch connects to a second transmission line connected to the second terminal station, a first output port of the second optical switch connects to a second transmission line connected to the first terminal station, and a second output port of the second optical switch connects to a second transmission line connected to the third terminal station.

### (Supplementary Note 18)

The program according to supplementary note 17, further causing a computer to execute processing of, in a case where an optical signal transmission path is being established between a first transmission line connected to the first terminal station and a first transmission line connected to the second terminal station, between a second transmission line connected to the first terminal station and a first transmission line connected to the third terminal station, and between a second transmission line connected to the third terminal station and a second transmission line connected to the second terminal station:
controlling the first optical switch in such a way that the first optical switch connects the first input port and the second output port to each other, and connects the second input port and the first output port to each other; and
controlling the second optical switch in such a way that the second optical switch connects the first input port and the first output port to each other, and connects the second input port and the second output port to each other.

### (Supplementary Note 19)

The program according to supplementary note 17, further causing a computer to execute processing of, in a case where an optical signal transmission path is being established between a first transmission line connected to the first terminal station and a first transmission line connected to the second terminal station, and between a second transmission line connected to the first terminal station and a second transmission line connected to the second terminal station:
controlling the first optical switch in such a way that the first optical switch connects the first input port and the second output port to each other, and connects the second input port and the first output port to each other; and
controlling the second optical switch in such a way that the second optical switch connects the first input port and the second output port to each other, and connects the second input port and the first output port to each other.

### (Supplementary Note 20)

The program according to supplementary note 17, further causing a computer to execute processing of, in a case where an optical signal transmission path is being established between a first transmission line connected to the second terminal station and a first transmission line connected to the third terminal station, and between a second transmission line connected to the second terminal station and a second transmission line connected to the third terminal station:
controlling the first optical switch in such a way that the first optical switch connects the first input port and the first output port to each other, and connects the second input port and the second output port to each other; and
controlling the second optical switch in such a way that the second optical switch connects the first input port and the first output port to each other, and connects the second input port and the second output port to each other.

### (Supplementary Note 21)

The program according to supplementary note 17, further causing a computer to execute processing of controlling switching of a transmission path in third and fourth optical switches, wherein
the optical switch drive circuit further includes the third and fourth optical switches having first and second input ports to which an optical signal is input and first and second output ports which output an optical signal, the third and fourth optical switches being capable of switching the optical signal transmission path between the input port and the output port,
a first input port of a third optical switch connects to a first output port of a fourth optical switch, a second input port of the third optical switch connects to a first transmission line connected to a second terminal station, a first output port of the third optical switch connects to a first transmission line connected to the first terminal station, and a second output port of the third optical switch connects to a first transmission line connected to the third terminal station, and
a first input port of the fourth optical switch connects to a second transmission line connected to the first terminal station, a second input port of the fourth optical switch connects to a second transmission line connected to the third terminal station, a first output port of the fourth optical switch connects to a transmission line connected to a first output port of the third optical switch, and a second output port of the fourth optical switch connects to a second transmission line connected to the second terminal station.

### (Supplementary Note 22)

The program according to supplementary note 21, further causing a computer to execute processing of, in a case where an optical signal transmission path is being established between a first transmission line connected to the first terminal station and a first transmission line connected to the second terminal station, between a second transmission line connected to the first terminal station and a first transmission line connected to the third terminal station, and between a second transmission line connected to the third terminal station and a second transmission line connected to the second terminal station:
controlling the third optical switch in such a way that the third optical switch connects the first input port and the second output port to each other, and connects the second input port and the first output port to each other; and
controlling the fourth optical switch in such a way that the fourth optical switch connects the first input port and the first output port to each other, and connects the second input port and the second output port to each other.

### (Supplementary Note 23)

The program according to supplementary note 21, further causing a computer to execute processing of, in a case where an optical signal transmission path is being established between a first transmission line connected to the first terminal station and a first transmission line connected to the second terminal station, and between a second transmission line connected to the first terminal station and a second transmission line connected to the second terminal station:
controlling the third optical switch in such a way that the third optical switch connects the first input port and the second output port to each other, and connects the second input port and the first output port to each other; and
controlling the fourth optical switch in such a way that the fourth optical switch connects the first input port and the second output port to each other, and connects the second input port and the first output port to each other.

### (Supplementary Note 24)

The program according to supplementary note 21, further causing a computer to execute processing of, in a case where an optical signal transmission path is being established between a first transmission line connected to the second terminal station and a first transmission line connected to the third terminal station, and between a second transmission line connected to the second terminal station and a second transmission line connected to the third terminal station:
controlling the third optical switch in such a way that the third optical switch connects the first input port and the first output port to each other, and connects the second input port and the second output port to each other; and
controlling the fourth optical switch in such a way that the fourth optical switch connects the first input port and the first output port to each other, and connects the second input port and the second output port to each other.

What is claimed is:

1. A branching apparatus comprising an optical switch drive circuit, wherein
the optical switch drive circuit is configured to include first and second optical switches having first and second input ports to which an optical signal is input and first and second output ports which output an optical signal, the first and second optical switches being capable of switching an optical signal transmission path between the input port and the output port,
a first input port of the first optical switch connects to a first transmission line connected to a first terminal station, a second input port of the first optical switch connects to a first transmission line connected to a third terminal station, a first output port of the first optical switch connects to a transmission line connected to a first input port of the second optical switch, and a second output port of the first optical switch connects to a first transmission line connected to a second terminal station, and
a first input port of the second optical switch connects to a transmission line connected to a first output port of the first optical switch, a second input port of the second optical switch connects to a second transmission line connected to the second terminal station, a first output port of the second optical switch connects to a second transmission line connected to the first terminal station, and a second output port of the second optical switch connects to a second transmission line connected to the third terminal station.

2. The branching apparatus according to claim 1, wherein, in a case where an optical signal transmission path is being established between a first transmission line connected to the first terminal station and a first transmission line connected to the second terminal station, between a second transmission line connected to the first terminal station and a first transmission line connected to the third terminal station, and between a second transmission line connected to the third terminal station and a second transmission line connected to the second terminal station,
the first optical switch connects the first input port and the second output port to each other, and connects the second input port and the first output port to each other, and
the second optical switch connects the first input port and the first output port to each other, and connects the second input port and the second output port to each other.

3. The branching apparatus according to claim 1, wherein, in a case where an optical signal transmission path is being established between a first transmission line connected to the first terminal station and a first transmission line connected to the second terminal station, and between a second transmission line connected to the first terminal station and a second transmission line connected to the second terminal station,
the first optical switch connects the first input port and the second output port to each other, and connects the second input port and the first output port to each other, and
the second optical switch connects the first input port and the second output port to each other, and connects the second input port and the first output port to each other.

4. The branching apparatus according to claim 1, wherein, in a case where an optical signal transmission path is being established between a first transmission line connected to the second terminal station and a first transmission line connected to the third terminal station, and between a second transmission line connected to the second terminal station and a second transmission line connected to the third terminal station,
the first optical switch connects the first input port and the first output port to each other, and connects the second input port and the second output port to each other, and
the second optical switch connects the first input port and the first output port to each other, and connects the second input port and the second output port to each other.

5. The branching apparatus according to claim 1, wherein the optical switch drive circuit further includes third and fourth optical switches having first and second input ports to which an optical signal is input and first and second output ports which output an optical signal, the third and fourth optical switches being capable of switching an optical signal transmission path between the input port and the output port,
a first input port of a third optical switch connects to a first output port of a fourth optical switch, a second input port of the third optical switch connects to a first transmission line connected to the second terminal station, a first output port of the third optical switch connects to a first transmission line connected to the first terminal station, and a second output port of the third optical switch connects to a first transmission line connected to the third terminal station, and
a first input port of the fourth optical switch connects to a second transmission line connected to the first terminal station, a second input port of the fourth optical switch connects to a second transmission line connected to the third terminal station, a first output port of the fourth optical switch is connected to a transmission line connected to a first input port of the third optical switch, and a second output port of the fourth optical switch is connected to a second transmission line connected to the second terminal station.

6. The branching apparatus according to claim 5, wherein, in a case where an optical signal transmission path is being established between a first transmission line connected to the first terminal station and a first transmission line connected to the second terminal station, between a second transmission line connected to the first terminal station and a first transmission line connected to the third terminal station, and between a second transmission line connected to the third terminal station and a second transmission line connected to the second terminal station,
the third optical switch connects the first input port and the second output port to each other, and connects the second input port and the first output port to each other, and
the fourth optical switch connects the first input port and the first output port to each other, and connects the second input port and the second output port to each other.

7. The branching apparatus according to claim 5, wherein, in a case where an optical signal transmission path is being established between a first transmission line connected to the first terminal station and a first transmission line connected to the second terminal station, and between a second transmission line connected to the first terminal station and a second transmission line connected to the second terminal station,
the third optical switch connects the first input port and the second output port to each other, and connects the second input port and the first output port to each other, and
the fourth optical switch connects the first input port and the second output port to each other, and connects the second input port and the first output port to each other.

8. The branching apparatus according to claim 5, wherein, in a case where an optical signal transmission path is being established between a first transmission line connected to the second terminal station and a first transmission line connected to the third terminal station, and between a second transmission line connected to the second terminal station and a second transmission line connected to the third terminal station,
the third optical switch connects the first input port and the first output port to each other, and connects the second input port and the second output port to each other, and
the fourth optical switch connects the first input port and the first output port to each other, and connects the second input port and the second output port to each other.

9. A method for controlling a branching apparatus comprising controlling switching of a transmission path in first and second optical switches, wherein
the branching apparatus is configured to include an optical switch drive circuit which includes the first and second optical switches having first and second input ports to which an optical signal is input and first and second output ports which output an optical signal, the first and second optical switches being capable of switching the optical signal transmission path between the input port and the output port,
a first input port of the first optical switch connects to a first transmission line connected to a first terminal station, a second input port of the first optical switch connects to a first transmission line connected to a third terminal station, a first input port of the first optical switch is connected to a transmission line connected to a first input port of the second optical switch, and a second output port of the first optical switch connects to a first transmission line connected to a second terminal station, and
a first input port of the second optical switch connects to a transmission line connected to a first output port of the first optical switch, a second input port of the second optical switch connects to a second transmission line connected to the second terminal station, a first output port of the second optical switch connects to a second transmission line connected to the first terminal station, and a second output port of the second optical switch connects to a second transmission line connected to the third terminal station.

10. The method for controlling the branching apparatus according to claim 9 further comprising, in a case where an optical signal transmission path is being established between a first transmission line connected to the first terminal station and a first transmission line connected to the second terminal station, between a second transmission line connected to the first terminal station and a first transmission line connected to the third terminal station, and between a second transmission line connected to the third terminal station and a second transmission line connected to the second terminal station:
controlling the first optical switch in such a way that the first optical switch connects the first input port and the second output port to each other, and connects the second input port and the first output port to each other; and
controlling the second optical switch in such a way that the second optical switch connects the first input port and the first output port to each other, and connects the second input port and the second output port to each other.

11. The method for controlling the branching apparatus according to claim 9 further comprising, in a case where an optical signal transmission path is being established between a first transmission line connected to the first terminal station and a first transmission line connected to the second terminal station, and between a second transmission line connected to the first terminal station and a second transmission line connected to the second terminal station:
controlling the first optical switch in such a way that the first optical switch connects the first input port and the second output port to each other, and connects the second input port and the first output port to each other; and
controlling the second optical switch in such a way that the second optical switch connects the first input port and the second output port to each other, and connects the second input port and the first output port to each other.

12. The method for controlling the branching apparatus according to claim 9 further comprising, in a case where an optical signal transmission path is being established between a first transmission line connected to the second terminal station and a first transmission line connected to the third terminal station, and between a second transmission line connected to the second terminal station and a second transmission line connected to the third terminal station:
controlling the first optical switch in such a way that the first optical switch connects the first input port and the first output port to each other, and connects the second input port and the second output port to each other; and
controlling the second optical switch in such a way that the second optical switch connects the first input port and the first output port to each other, and connects the second input port and the second output port to each other.

13. The method for controlling the branching apparatus according to claim 9, further comprising controlling switching of a transmission path in third and fourth optical switches, wherein
the optical switch drive circuit further includes the third and fourth optical switches having first and second input ports to which an optical signal is input and first and second output ports which output an optical signal, the third and fourth optical switches being capable of switching the optical signal transmission path between the input port and the output port,
a first input port of a third optical switch connects to a first output port of a fourth optical switch, a second input port of the third optical switch connects to a first transmission line connected to a second terminal station, a first output port of the third optical switch connects to a first transmission line connected to the first terminal station, and a second output port of the third optical switch connects to a first transmission line connected to the third terminal station, and
a first input port of the fourth optical switch connects to a second transmission line connected to the first terminal station, a second input port of the fourth optical switch connects to a second transmission line connected to the third terminal station, a first output port of the fourth optical switch connects to a transmission line connected to a first input port of the third optical switch, and a second output port of the fourth optical switch connects to a second transmission line connected to the second terminal station.

14. The method for controlling the branching apparatus according to claim 13, further comprising, in a case where an optical signal transmission path is being established between a first transmission line connected to the first terminal station and a first transmission line connected to the second terminal station, between a second transmission line connected to the first terminal station and a first transmission line connected to the third terminal station, and between a second transmission line connected to the third terminal station and a second transmission line connected to the second terminal station:
controlling the third optical switch in such a way that the third optical switch connects the first input port and the second output port to each other, and connects the second input port and the first output port to each other; and
controlling the fourth optical switch in such a way that the fourth optical switch connects the first input port and the first output port to each other, and connects the second input port and the second output port to each other.

15. The method for controlling the branching apparatus according to claim 13 further comprising, in a case where an optical signal transmission path is being established between a first transmission line connected to the first terminal station and a first transmission line connected to the second terminal station, and between a second transmission line connected to the first terminal station and a second transmission line connected to the second terminal station:
controlling the third optical switch in such a way that the third optical switch connects the first input port and the second output port to each other, and connects the second input port and the first output port to each other; and
controlling the fourth optical switch in such a way that the fourth optical switch connects the first input port and the second output port to each other, and connects the second input port and the first output port to each other.

16. The method for controlling the branching apparatus according to claim 13 further comprising, in a case where an optical signal transmission path is being established between a first transmission line connected to the second terminal station and a first transmission line connected to the third terminal station, and between a second transmission line connected to the second terminal station and a second transmission line connected to the third terminal station:
controlling the third optical switch in such a way that the third optical switch connects the first input port and the first output port to each other, and connects the second input port and the second output port to each other; and
controlling the fourth optical switch in such a way that the fourth optical switch connects the first input port and the first output port to each other, and connects the second input port and the second output port to each other.

17. A non-transitory computer readable medium storing a program causing a computer to execute processing of controlling switching of a transmission path in first and second optical switches, wherein
the branching apparatus is configured to include an optical switch drive circuit which includes the first and second optical switches having first and second input ports to which an optical signal is input and first and second output ports which output an optical signal, the first and second optical switches being capable of switching the optical signal transmission path between the input port and the output port,
a first input port of the first optical switch connects to a first transmission line connected to a first terminal station, a second input port of the first optical switch connects to a first transmission line connected to a third terminal station, a first input port of the first optical switch is connected to a transmission line connected to a first input port of the second optical switch, and a second output port of the first optical switch connects to a first transmission line connected to a second terminal station, and
a first input port of the second optical switch connects to a transmission line connected to a first output port of the first optical switch, a second input port of the second optical switch connects to a second transmission line connected to the second terminal station, a first output port of the second optical switch connects to a second transmission line connected to the first terminal station, and a second output port of the second optical switch connects to a second transmission line connected to the third terminal station.

18. The non-transitory computer readable medium storing the program according to claim 17, further causing a computer to execute processing of, in a case where an optical signal transmission path is being established between a first transmission line connected to the first terminal station and a first transmission line connected to the second terminal station, between a second transmission line connected to the first terminal station and a first transmission line connected to the third terminal station, and between a second transmission line connected to the third terminal station and a second transmission line connected to the second terminal station:
controlling the first optical switch in such a way that the first optical switch connects the first input port and the second output port to each other, and connects the second input port and the first output port to each other; and
controlling the second optical switch in such a way that the second optical switch connects the first input port and the first output port to each other, and connects the second input port and the second output port to each other.

19. The non-transitory computer readable medium storing the program according to claim 17, further causing a computer to execute processing of, in a case where an optical signal transmission path is being established between a first transmission line connected to the first terminal station and a first transmission line connected to the second terminal station, and between a second transmission line connected to the first terminal station and a second transmission line connected to the second terminal station:
controlling the first optical switch in such a way that the first optical switch connects the first input port and the second output port to each other, and connects the second input port and the first output port to each other; and
controlling the second optical switch in such a way that the second optical switch connects the first input port and the second output port to each other, and connects the second input port and the first output port to each other.

20. The non-transitory computer readable medium storing the program according to claim 17, further causing a computer to execute processing of, in a case where an optical signal transmission path is being established between a first transmission line connected to the second terminal station and a first transmission line connected to the third terminal station, and between a second transmission line connected to the second terminal station and a second transmission line connected to the third terminal station:
controlling the first optical switch in such a way that the first optical switch connects the first input port and the first output port to each other, and connects the second input port and the second output port to each other; and
controlling the second optical switch in such a way that the second optical switch connects the first input port and the first output port to each other, and connects the second input port and the second output port to each other.
